(19) United States
(12) Patent Application Publication
(10) Pub. No.: US 2026/0291968 A1
(43) Pub. Date: Sep. 24, 2026

(54) DETECTING ANOMALOUS DNS QUERY SEMANTICS

(71) Applicant: Oracle International Corporation, Redwood Shores, CA (US)

(72) Inventors: Christopher Robert Baker, Nashua, NH (US); Jonathan Philip Taimanglo, Arlington, VA (US); Peter Martin Hanily, Dublin (IE); Ryan Daniel Schilcher, Seattle, WA (US); Andreea Constantin, Bucharest (RO)

(73) Assignee: Oracle International Corporation, Redwood Shores, CA (US)

(21) Appl. No.: 19/086,683

(22) Filed: Mar. 21, 2025

(30) Foreign Application Priority Data
Mar. 21, 2025 (RO) A100172025

(51) Int. Cl. H04L 9/40; H04L 61/4511

(52) U.S. Cl. CPC H04L 63/1425; H04L 61/4511

(57) ABSTRACT

Techniques for detecting anomalous domain name system (DNS) query semantics are disclosed. A DNS query, which is to be routed to a DNS server, is received. The DNS query is parsed. Sensitive information within the DNS query is detected. In response to detecting the sensitive information within the DNS query, the DNS query is flagged as including the sensitive information. In an example, in response to flagging the DNS query as including the sensitive information, the DNS query is blocked from being transmitted to its target destination.

### CROSS REFERENCE TO RELATED APPLICATION

This application claims priority under 35 U.S.C. § 119(a) to Romanian Patent Registration No. A/10017/2025, filed on Mar. 21, 2025. The entire disclosure of the aforementioned application is incorporated by reference herein in its entirety for all purposes.

### BACKGROUND

A DNS (Domain Name System) query is a request sent from a client (such as a web browser, a computer, a mobile phone) to a DNS server, e.g., to resolve a domain name into an Internet Protocol (IP) address. For example, when a user types a website address (e.g., www.abc.example.com) in a browser of a device (such as a computer or a mobile phone), the device has to find a corresponding IP address to connect to the website. The operating system of the device checks its local DNS cache to see the IP address is cached within the local cache. If the IP address is not cached within the local cache, a DNS query is sent to a DNS resolver, which is usually provided by an Internet Service Provider (ISP) of the device or a public DNS service. The DNS resolver checks its own cache to see if the corresponding IP address is cached within its own cache. If the IP address is not cached by the DNS resolver, the DNS resolver may contact a root DNS server and/or a TLD (Top-Level Domain) server (e.g., .com, .org, .net servers). The root DNS server and/or the TLD respond with the address of an authoritative DNS server for the domain.

The DNS resolver contacts the authoritative DNS server specific to the domain name of the website address. For example, if the website address is www.abc.example.com, the DNS query is routed to the authoritative DNS server for the domain name example.com. Thus, the DNS query raised by the client is routed to the authoritative DNS server. The authoritative DNS server provides the final IP address corresponding to the requested website address. Thus, a DNS query translates a human-readable domain or website name into an IP address, allowing devices to find and connect to websites or services on the Internet.

### BRIEF SUMMARY

In various embodiments, a non-transitory computer-readable medium includes instructions that when executed by one or more processors, cause the one or more processors to perform operations including: receiving a Domain Name System (DNS) query to be routed to a DNS server; parsing the DNS query; detecting sensitive information within the DNS query; and in response to detecting the sensitive information within the DNS query, flagging the DNS query as including the sensitive information. In an example, the operations include: in response to flagging the DNS query as including the sensitive information, refraining from transmitting the DNS query to its target destination. In an example, detecting the sensitive information within the DNS query comprises: detecting the sensitive information within a QNAME (Query Name) portion of the DNS query. In an example, the sensitive information is within a subdomain name of the DNS query.

In an example, detecting the sensitive information within the DNS query comprises: detecting the sensitive information in a cleartext format within the DNS query. In an example, detecting the sensitive information within the DNS query comprises: parsing the DNS query to identify a text within the DNS query; decoding the text to generate decoded text; and identifying the decoded text to include the sensitive information. In an example, detecting the sensitive information within the DNS query comprises: parsing the DNS query to identify a text within the DNS query; decoding the text using a plurality of decoding techniques, to respectively generate a plurality of decoded texts; and parsing the plurality of decoded texts, to identifying the sensitive information within a first decoded text of the plurality of decoded texts. In an example, the sensitive information comprises a name or an identification of a compute resource within a cloud environment.

In an example, the operations include: detecting, within the DNS query, a type of the sensitive information. In an example, the operations include: detecting, within the DNS query, one of (i) an indication of a type of encoding used to encode the sensitive text within the DNS query, or (ii) an indication of a type of decoding to be used to decode sensitive text within the DNS query. In an example, the operations include: detecting, within the DNS query, an indication of a type of vulnerability to be exploited using the sensitive information.

In an example, the DNS query is received from a cloud resource within a client section of a cloud environment; and the sensitive information is detected within a cloud provider section or an assurance administrator section of the cloud environment.

In various embodiments, a method comprises: receiving a Domain Name System (DNS) query to be routed to a DNS server; parsing the DNS query; detecting sensitive information within the DNS query; and in response to detecting the sensitive information within the DNS query, flagging the DNS query as including the sensitive information. In an example, the method further comprises: in response to flagging the DNS query as including the sensitive information, refraining from transmitting the DNS query to its target destination. In an example, the sensitive information is within a subdomain name of the DNS query.

In an example, detecting the sensitive information within the DNS query comprises: parsing the DNS query to identify a text within the DNS query; decoding the text to generate decoded text; and identifying the decoded text to include the sensitive information. In an example, detecting the sensitive information within the DNS query comprises: parsing the DNS query to identify a text within the DNS query; decoding the text using a plurality of decoding techniques, to respectively generate a plurality of decoded texts; and parsing the plurality of decoded texts, to identifying the sensitive information within a first decoded text of the plurality of decoded texts. In an example, the sensitive information comprises a name or an identification of a compute resource within a cloud environment.

In various embodiments, a system comprises: one or more processors; and one or more non-transitory computer-readable media storing instructions, which, when executed by the system, cause the system to perform a set of actions including: receiving a Domain Name System (DNS) query to be routed to a DNS server; parsing the DNS query; detecting sensitive information within the DNS query; and in response to detecting the sensitive information within the DNS query, flagging the DNS query as including the sensitive information. In an example, the sensitive information comprises a name or an identification of a compute resource within a cloud environment.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a block diagram of a cloud environment that includes (i) a cloud resource aiming to transmit DNS queries to outside the cloud environment, and (ii) an egress analysis service analyzing the DNS queries for possible anomalous issues.

FIG. 2 illustrates a block diagram of a cloud environment that includes (i) a cloud resource transmitting DNS queries, and (ii) an egress analysis service analyzing the DNS queries for possible anomalous issues, and selectively blocking passage of a DNS query in response to detection of an anomalous issue associated with the DNS query.

FIG. 3 illustrates a block diagram of a cloud environment that includes (i) a cloud resource transmitting DNS queries, where a DNS query includes sensitive information in an encoded form, and (ii) an egress analysis service analyzing the DNS queries for possible anomalous issues, and selectively blocking passage of the DNS query in response to detection of an anomalous issue associated with the DNS query.

FIG. 4 illustrates a block diagram of a cloud environment that includes (i) a cloud resource transmitting DNS queries to outside the cloud environment, where a DNS query includes sensitive information in an encoded form, and an indication of an encoding scheme used for encoding the sensitive information, and (ii) an egress analysis service analyzing the DNS queries for possible anomalous issues, and selectively blocking passage of a DNS query in response to detection of an anomalous issue associated with the DNS query.

FIGS. 5A, 5B, 5C, 5D, 5E and 5F illustrate various example DNS queries that sensitive information that can be exploited by a threat actor.

FIG. 6 illustrates a flow chart depicting a method for detection of anomalous DNS queries.

FIG. 7 depicts a simplified diagram of a distributed system for implementing certain aspects.

FIG. 8 is a simplified block diagram of one or more components of a system environment by which services provided by one or more components of an embodiment system may be offered as cloud services, in accordance with certain aspects.

FIG. 9 illustrates an example computer system that may be used to implement certain aspects.

### DETAILED DESCRIPTION

As described above, if an internet protocol (IP) address of a domain name is not cached in a local device or a DNS resolver, a DNS query is transmitted to a DNS server (such as an authoritative DNS server). The DNS query includes a QNAME (Query Name) portion, which includes the domain and subdomain name to be resolved. As described below, in an example, a threat actor may use DNS queries to exfiltrated sensitive information, e.g., by embedding the sensitive information (or an encoded version of the sensitive information) within the DNS query, such as within the subdomain name of the DNS query.

An example scenario where DNS queries may be used to exfiltrate sensitive information is as follows. A provider of a cloud environment provides on-demand, scalable computing resources (a cloud environment) to its cloud customers. The cloud provider provides each cloud customer a “tenancy.” Thus, a cloud customer rents the tenancy from the cloud provider. Each tenancy has a plurality of cloud resources, such as compute instances, virtual networking resources, memory resources, databases, and/or other types of cloud resources. In general, cloud resources operating within a cloud environment can transmit data to outside the cloud environment. In a typical scenario, data being transmitted to and/or from a cloud resource are not monitored by the provider of the cloud environment. For example, a cloud customer may ingress and/or egress data to and/or from the cloud environment, with little or no oversight from the provider of the cloud environment. However, in the context of software assurance, in an example, an additional role of an assurance administrator is added into the picture. The assurance administrator may or may not be the same as the cloud provider. In an example, the assurance administrator acts as a “trusted technology provider” (TTP). In an example, the assurance administrator needs to have a role or control over data ingress and/or egress to and/or from one or more cloud resources within the cloud environment (such as to and/or from a customer tenancy within the cloud environment). Accordingly, the assurance administrator may monitor data being transmitted by a cloud resource to outside of the cloud environment. In an example, a threat actor may want to circumvent such measures of the assurance administrator, and the assurance administrator may want to monitor and deter such efforts by the threat actor.

In an example, any egress request from a cloud resource and to a public network (such as the Internet) is routed through an egress analysis service that is maintained by the provider of the cloud environment and/or the assurance administrator. The egress analysis service analyses one or more requests that are to be routed from a cloud resource to outside the cloud environment. In an example, communication from the cloud resource to outside the cloud environment is monitored by the egress analysis service.

In an example, the cloud resource may be operated by a threat actor, which wants to exfiltrate sensitive information from the cloud resource to outside the cloud environment. However, as the egress analysis service monitors communication from the cloud resource to outside the cloud environment, it may be challenging for the cloud resource to transmit the sensitive information to outside the cloud environment through the egress analysis service and using usual data communication channels. Accordingly, in an example, the cloud resource operated by the threat actor may rely on DNS queries, to exfiltrate sensitive information to outside the cloud environment.

In an example, the cloud resource transmits DNS queries to outside the cloud environment, e.g., to a DNS server (such as an authoritative DNS server), to resolve a domain name (e.g., example.com) into an IP address (e.g., 192.0.2.1). Note that if the website address within the DNS query is unique enough, the DNS query from the cloud resource reaches the DNS server, as the corresponding IP address is unlikely to be saved within the local cache of the cloud resource and/or the cache of the DNS resolver.

Accordingly, in an example, the cloud resource may want to exfiltrate sensitive information to outside the cloud environment, e.g., using DNS queries. For example, the cloud resource may attempt to embed the sensitive information within one or more DNS queries, hoping that the egress analysis service may not analyze the DNS queries originating from the cloud resource. For example, the rouge cloud resource may embed the sensitive information (or an encoded version of the sensitive information) within the DNS query, such as within the subdomain name of the DNS query. The cloud resource then attempts to transmit the DNS query, with the sensitive information (or the encoded version of the sensitive information) embedded therewithin, to the DNS server. The DNS server may also be operated by the threat actor (or the threat actor may have access to DNS queries received by the DNS server). Once the DNS server receives the DNS query, the DNS server may or may not respond to the DNS query. However, once the DNS server receives the DNS query, the DNS server has access to the sensitive information (or the encoded version of the sensitive information) that was embedded within the DNS query. Now the threat actor also has access to the sensitive information (or the encoded version of the sensitive information), which the threat actor may use for malicious purposes.

Accordingly, techniques are disclosed herein for detecting anomalous DNS query semantics. For example, a DNS checker service receives a DNS query, which is to be routed to a DNS server. The DNS checker service parses the DNS query. For example, the DNS checker service tries to correlate subdomain names within the DNS query with a list of sensitive information. In an example, the sensitive information may include a host name or a namespace that is internal to the cloud environment, and need not be transmitted outside the cloud environment. Other examples of the sensitive information may also be possible. Note that while various examples of such sensitive information are described below in further detail, the teachings of this disclosure are not limited to any specific type of sensitive information.

If the DNS checker service detects a positive correlation between the subdomain names within the DNS query and at least one sensitive information within the list of sensitive information, the DNS checker service issues a flag declaring that the DNS query may possible be anomalous. In an example, the DNS checker service may also block passage of the DNS query to its target destination (which may be the DNS server).

Note that to avoid detection by the DNS checker service, the threat actor may cause the cloud resource to encode the sensitive information within the DNS query. To detect such encoded sensitive information embedded within a DNS query, in an example, the DNS checker service receives the original DNS query, and decodes various texts included within the subdomain names of the original DNS query. Note that at this point, the DNS checker service may not know whether any sensitive information within the DNS query is encoded, and also may not know an encoding technique that may have been used to encode the sensitive information. Accordingly, in an example, a decoder within the DNS checker service implements a plurality of decoding techniques corresponding to a plurality of known encoding techniques. For example, the decoder decodes texts within the DNS query (i) in accordance with a first decoding technique, to generate a first decoded DNS query, (ii) in accordance with a second decoding technique, to generate a second decoded DNS query, and so on. A correlation service aims to correlate each of the plurality of decoded DNS queries, as well as the original DNS query, with a list of sensitive information. Upon detecting a positive correlation or match, the DNS checker service issues a flag and possibly block passage of the DNS query to the DNS server.

In an example, in additional to embedding sensitive information within a DNS query, the rogue cloud resource may also include one or more attributes or additional information about the embedded sensitive information within the DNS query. For example, if the sensitive information is encoded using a specific encoding technique, the DNS query may also include an identification of the encoding technique. Merely as an example, if base64 encoding is used to encode sensitive information, a first subdomain of the DNS query may include the encoded sensitive information, and a second subdomain may include “b64,” or “base64,” or “64,” indicating that the sensitive information is encoded using base64 encoding. Appropriate variation of such indicating may also be possible. The DNS server, upon receiving the DNS query, can decode the sensitive information using the indication of the encoding technique. In an example, the DNS checker service may be configured to detect such indication of the encoding technique, and accordingly decode the encoded sensitive information within the DNS query, as described below in further detail.

In an example, a DNS query may include an indication of a vulnerability to be exploited, as well as relevant information associated with the vulnerability. Merely as an example, the DNS query may be of the form vulnarabilityname.vulnarabilityinfo.examplethreat.com. The vulnarabilityname indicates a name or at least an indication of a vulnerability, and the vulnarabilityinfo includes additional information that can be used to exploit the vulnerability. In an example, the DNS checker service described herein can detect such an attempt to exfiltrate such vulnerability information, e.g., by detecting the vulnarabilityname and/or the vulnarabilityinfo from the DNS query. Various variations in embedding sensitive information within the DNS query, and techniques to detect such embedded sensitive information have been described below in further detail.

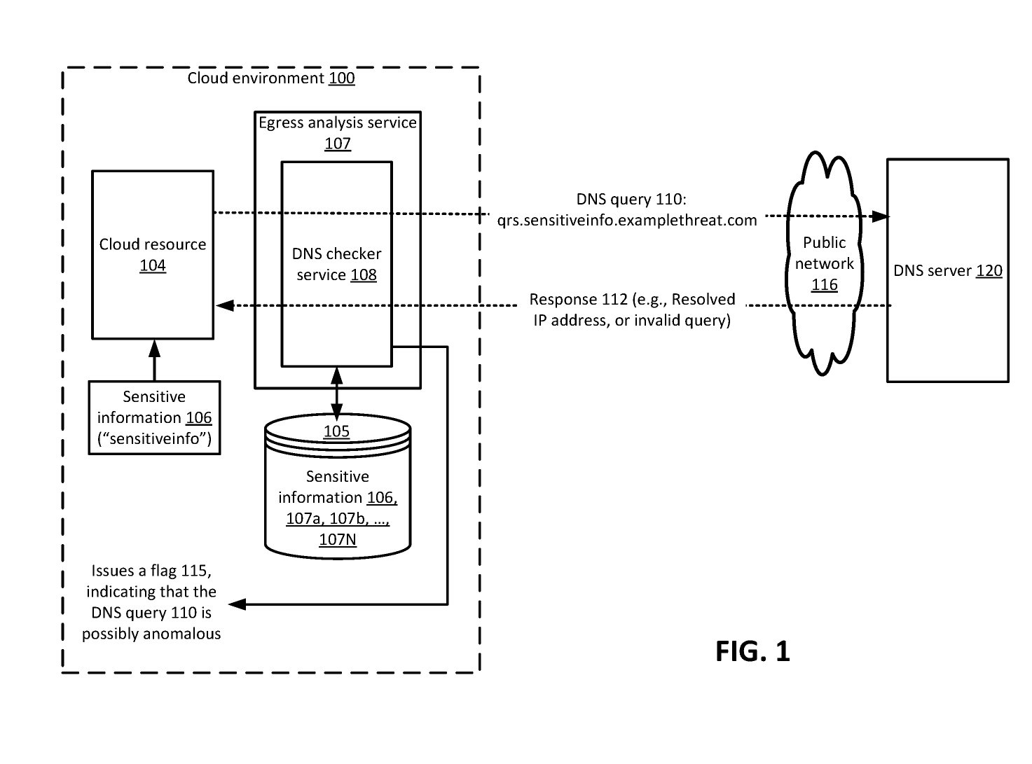

FIG. 1 illustrates a block diagram of a cloud environment 100 that includes (i) a cloud resource 104 aiming to transmit DNS queries to outside the cloud environment 100, and (ii) an egress analysis service analyzing the DNS queries for possible anomalous issues. A provider of the cloud environment 100 provides on-demand, scalable computing resources (a cloud environment) to its cloud customers. The cloud provider provides each cloud customer a “tenancy.” Thus, a cloud customer rents the tenancy from the cloud provider. A tenancy is an isolated partition within the cloud environment 101, such that resources in different tenancies are isolated from each other unless explicitly shared. A tenancy (not illustrated in FIG. 1) of a cloud customer is isolated from another tenancy of another cloud customer.

Each tenancy has a plurality of cloud resources, such as an example cloud resource 104 illustrated in FIG. 1. The cloud resource 104 may be any appropriate type of cloud resource deployed in a tenancy of a cloud customer. Examples of the cloud resource 104 include a compute instance, a virtual networking resource, a memory device, a database, and/or another type of a cloud resource.

Cloud resources operating within a cloud environment (such as the cloud resource 104 of the cloud environment 100) can transmit data to outside the cloud environment. In a typical scenario, data being transmitted to and/or from a cloud resource are not monitored by the provider of the cloud environment. For example, a cloud customer may ingress and/or egress data to and/or from the cloud environment, with little or no oversight from the provider of the cloud environment.

However, in the context of software assurance, in an example, an additional role of an assurance administrator is added into the picture. The assurance administrator may or may not be the same as the cloud provider. In an example, the assurance administrator acts as a “trusted technology provider” (TTP). In an example, the assurance administrator needs to have a role or control over data ingress and/or egress to and/or from one or more cloud resources within the cloud environment (such as to and/or from a customer tenancy within the cloud environment). Accordingly, the assurance administrator may monitor data being transmitted by a cloud resource (such as the cloud resource 104) to outside of the cloud environment 100. In an example, a threat actor may want to circumvent such measures of the assurance administrator, and the assurance administrator may want to monitor and deter such efforts by the threat actor.

The cloud resource 104 has access to outside the cloud environment 100, e.g., through a public network 116, such as the Internet. The cloud resource 104 accesses a variety of information through the public network 116. In an example, any egress request from the cloud resource 104 and to the public network 116 is routed through the egress analysis service 107. The egress analysis service 107 analyses one or more requests that are to be routed from the cloud resource 104 to outside the cloud environment 100.

In an example, the cloud resource 104 transmits DNS (Domain Name System) queries (such as an example DNS query 110 illustrated in FIG. 1) to outside the cloud environment 100. The DNS query 101 is a request made by the cloud resource 104 to a DNS server, to resolve a domain name (e.g., example.com) into an IP address (e.g., 192.0.2.1). This process allows the cloud resource 104 to access websites using human-readable names (e.g., example.com) instead of numerical IP addresses.

In an example, communication from the cloud resource 104 to outside the cloud environment 100 is monitored by the egress analysis service 107. For example, data transmitted by the cloud resource 104 is monitored and possibly filtered by the egress analysis service 107. In an example, the cloud resource 104 may be operated by a threat actor, which wants to exfiltrate sensitive information 106 to outside the cloud environment 100. However, as the egress analysis service 107 monitors communication from the cloud resource 104 to outside the cloud environment 100, it may be challenging for the cloud resource 104 to transmit the sensitive information 106 to outside the cloud environment 100 through the egress analysis service 107 and using usual data communication channels.

Accordingly, in an example, the cloud resource 104 may want to exfiltrate sensitive information to outside the cloud environment 100, e.g., using DNS queries. For example, the cloud resource 104 may attempt to embed the sensitive information 106 within one or more DNS queries, hoping that the egress analysis service 107 may not analyze the DNS queries originating from the cloud resource 104.

Accordingly, in an example, to prohibit such malicious efforts by the cloud resource 104 to embed and exfiltrate sensitive information 106 through the DNS queries, the egress analysis service 107 also monitors and analyzes DNS queries transmitted by the cloud resource 104 to outside the cloud environment 100, as described below in further detail.

In an example, the cloud environment 100 includes a storage repository 105 storing sensitive information 106, 107a, ..., 107N. The sensitive information 106, 107a, ..., 107N may be any appropriate type of sensitive information that the provider of the cloud environment 100 deems to be sensitive enough, so that the provider of the cloud environment 100 does not want exfiltration of such sensitive information outside of the cloud environment 100. For example, the provider of the cloud environment 100 does not want the cloud resource 104 to transmit the sensitive information 106, 107a, ..., 107N to outside the cloud environment 100. Merely as an example, the sensitive information 106, 107a, ..., 107N may include one or more of a host name within the cloud environment, name of a VCN (virtual cloud network) within which the cloud resource 104 operates, name of another VCN within the cloud environment 100, an encryption key, snippets of a code, and/or any other type of sensitive information.

In an example, a sensitive information can include an internal namespace of an internal resource within the cloud environment (e.g., which is not supposed to be a public namespace, and hence, not supposed to be included within a domain name to be resolved over the public network 116). Merely as an example, the sensitive information 106 can have the form: hostname.VCNname.abccloudenvironment, where the hostname is a host name of a host within the cloud environment, the VCNname is a VCN including the host, and the xyzcloudenvironment is indicative of the cloud environment 100 (e.g., “xyz” is the name of the cloud environment 100). Thus, hostname.VCNname.xyzcloudenvironment is indicative of an internal namespace of the host within the cloud environment 100. Thus, in this example, the full domain name of the DNS query 110 is abc.hostname.VCNname.abccloudenvironment.examplethreat.com (e.g., the domain name is examplethreat in this example). Because this is an internal namespace of the cloud environment 100 and is not functional on the public Internet, there is no reason for the domain name within the DNS query 110 to include such sensitive information. In this example, an internal namespace within the cloud environment is embedded within a QNAME (Query Name) portion of a DNS query.

Note that although some example types of the sensitive information are described above, the sensitive information can be of another appropriate type. The teaching of this disclosure is not limited to any particular type of sensitive information.

Assume that the cloud resource 104 has access to at least the sensitive information 106, and wants to maliciously exfiltrate the sensitive information 106 to outside the cloud environment 100. The sensitive information 106 is assumed to have the text “sensitiveinfo,” although a practical implementation will have an actual text of an actual sensitive information. Thus, in the example of FIG. 1, the cloud resource 104 wants to exfiltrate the text “sensitiveinfo” to outside the cloud environment 100. However, as described above, due to the monitoring by the egress analysis service 107 of egress requests from the cloud resource 104 to outside the cloud environment 100, it may be difficult for the cloud resource 104 to exfiltrate the text “sensitiveinfo” to outside the cloud environment 100 using usual data communication channels. Accordingly, in an example, the cloud resource 104 may attempt to exfiltrate the text “sensitiveinfo” to outside the cloud environment 100 using a DNS query 110.

For example, the DNS query transmitted by the cloud resource 104 may be of the form qrs.sensitiveinfo.examplethreat.com. Thus, examplethreat.com is the domain of the DNS query address, with a subdomain name including the text “sensitiveinfo.” The address may include one or more other subdomain names, such as “qrs.”

Note that the text “sensitiveinfo” is unique enough such that a probability of an IP address corresponding to the DNS query being cached by the cloud environment 100 is relatively low. Accordingly, the DNS query 110 is routed to a DNS server 120. In an example, the DNS server 120 is an authoritative DNS server. In an example, the DNS server 120 is operated by a threat actor, or a threat actor has access to DNS queries being received by the DNS server 120. Thus, for example, the threat actor may have control over the domain name examplethreat.com, and set up the DNS server 120 for the domain name examplethreat.com, such that DNS queries for this domain name are routed to the DNS server 120.

When the cloud resource 104 transmits the DNS query 110 to the DNS server 120, the DNS server 120 parses the DNS query 110, and accesses the text “sensitiveinfo” within the DNS query 110. The threat actor, thus, now have access to the text “sensitiveinfo,” which the threat actor may use for malicious purposes.

Note that in an example, the DNS server 120 is being operated by a threat actor, e.g., for purposes of gathering sensitive information via DNS queries. Accordingly, the DNS server 120 may not have any obligation or need to correctly respond to the DNS query 110. Hence, the DNS server 120 may or may not respond to the DNS query 110. In one example, the DNS server 120 transmits a response 112 back to the cloud resource 104. In an example, the response 112 may include a resolved IP address. Here the IP address may be a real IP address corresponding to the domain examplethreat.com, or maybe a random IP address. In another example, the DNS server 120 transmits a 112 indicating that the DNS query 110 was invalid (e.g., included an invalid address). In a further example, the DNS server 120 may choose to not even respond to the DNS query 110.

In an example, the egress analysis service 107 comprises a DNS checker service 108, which is configured to check for DNS queries for any of the sensitive information 106, 107a, ..., 107N. For example, the DNS checker service 108 checks within the QNAME (Query Name) portion of the DNS query, such as within the domain and/or subdomain names for any of the sensitive information 106, 107a, ..., 107N. For example, the DNS checker service 108 correlates and compares the DNS query 110 with the texts of the sensitive information 106, 107a, ..., 107N.

In the example of FIG. 1, the DNS checker service 108 detects presence of the text “sensitiveinfo” within the QNAME portion of the DNS query, which corresponds to the sensitive information 106. Accordingly, in an example, the DNS checker service 108 issues a flag 115, indicating that the DNS query 110 is possibly anomalous and may possibly include sensitive information.

The provider of the cloud environment 100 may take corrective actions, in response to the DNS checker service 108 issuing the flag 116, indicating that the DNS query 110 is possibly anomalous and may possibly include sensitive information. For example, the provider of the cloud environment 100 and/or personnel of the assurance administrator may further parse the DNS query 110 to ensure that the DNS query 110 indeed has the sensitive information 106. In an example, the provider of the cloud environment 100 may blacklist the cloud resource 104 from transmitting any further DNS query. In an example, the provider of the cloud environment 100 may accuse the cloud customer (to whom the cloud resource 104 was rented) of exfiltrating sensitive information through DNS queries. In an example, the provider of the cloud environment 100 may report the cloud customer (to whom the cloud resource 104 was rented) to a regulatory authority, and/or may take actions against the cloud customer.

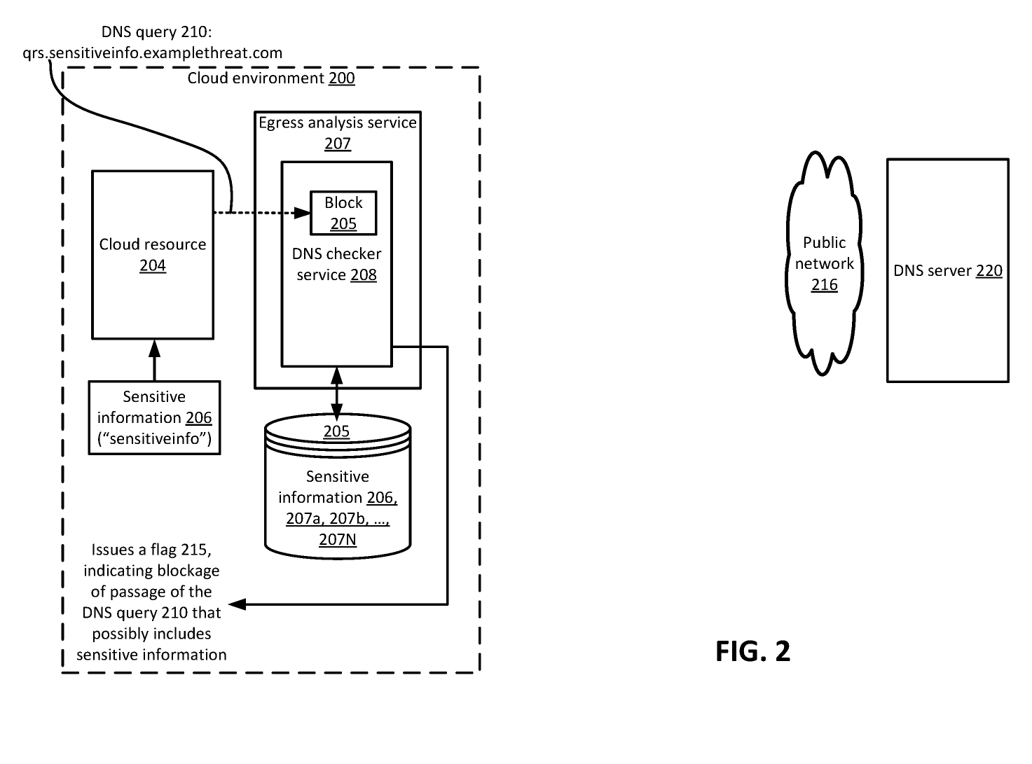

FIG. 2 illustrates a block diagram of a cloud environment 200 that includes (i) a cloud resource 204 transmitting DNS queries, and (ii) an egress analysis service analyzing the DNS queries for possible anomalous issues, and selectively blocking passage of a DNS query 210 in response to detection of an anomalous issue associated with the DNS query.

The cloud environment 200 of FIG. 2 is at least in part similar to the cloud environment 100 of FIG. 1. For example, the cloud environment 200 of FIG. 2 includes a cloud resource 204, an egress analysis service 207 including a DNS checker service 208, and a storage repository 205 including sensitive information 206, 207a, 207b, …, 207N. Similar to the scenario in FIG. 1, in FIG. 2 the cloud resource 204 aims to transmit a DNS query 210 that has an QNAME address of the form qrs.sensitiveinfo.examplethreat.com. Thus, the DNS query 210 also has the text “sensitiveinfo” as a subdomain.

In FIG. 1, the DNS checker 108 flags the DNS query 110, and allows the DNS query 110 to pass to the authoritative DNS server 120. In contrast, in FIG. 2, the DNS checker 208 blocks passage of the DNS query 210 to the authoritative DNS server 220. For example, based on comparing the DNS query 210 with the sensitive information 206, 207a, …, 207N and finding a correlation or match, the DNS checker 208 blocks passage of the DNS query 210 to the authoritative DNS server 220, which is symbolically illustrated with a box labelled “block 205” in FIG. 2. In an example, the DNS checker service 208 also issues a flag 215, indicating blockage of passage of the DNS query 210 that possibly includes sensitive information.

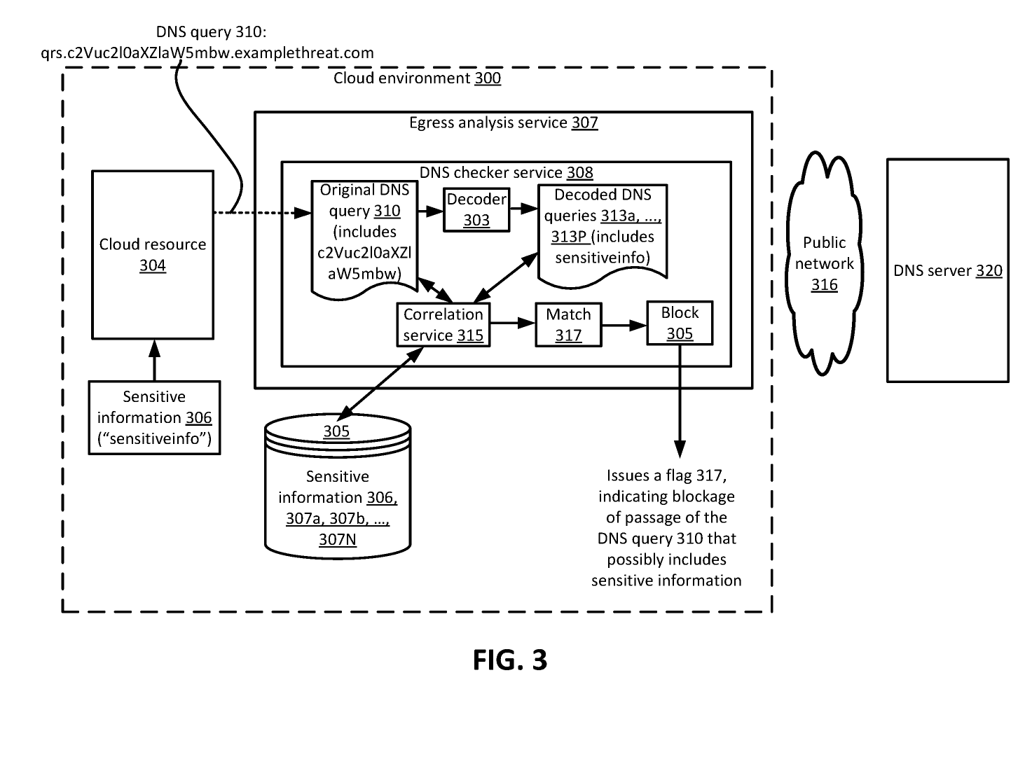

FIG. 3 illustrates a block diagram of a cloud environment 300 that includes (i) a cloud resource 304 transmitting DNS queries, where a DNS query 310 includes sensitive information in an encoded form, and (ii) an egress analysis service 307 analyzing the DNS queries for possible anomalous issues, and selectively blocking passage of the DNS query 310 in response to detection of an anomalous issue associated with the DNS query 310.

The cloud environment 300 of FIG. 3 is at least in part similar to the cloud environments 100 and 200 of FIGS. 1 and 2. For example, the cloud environment 300 of FIG. 3 includes a cloud resource 304, an egress analysis service 307 including a DNS checker service 308, and a storage repository 305 including sensitive information 306, 307a, 307b, …, 307N. In FIG. 3 the cloud resource 304 aims to transmit a DNS query 310 that includes an encoded version of the text “sensitiveinfo” as a subdomain.

Thus, in FIGS. 1 and 2, the DNS queries included sensitive information in cleartext and unencoded form. Accordingly, the DNS checker services 108 and/or 208 can relatively easily compare and correlate the DNS queries with the list of sensitive information stored in the storage repository 105 or 205 for a hit.

However, in an example, the threat actor may cause the cloud resource 304 to encode the sensitive information 306 (e.g., the text “sensitiveinfo”). Merely as an example, in FIG. 3, the cloud resource 304 encodes the text “sensitiveinfo” with base64 encoding. The base64 encoding of the text “sensitiveinfo” is c2Vuc2l0aXZlaW5mbw== (where the last two characters “==” are padding added to the encoded character). Accordingly, in an example, instead of adding the text “sensitiveinfo” to the address of the DNS query 310, an encoded version of the text “sensitiveinfo” (which is c2Vuc2l0aXZlaW5mbw) is added to the DNS query 310 by the rouge cloud resource 304.

In an example, the DNS checker service 308 receives the original DNS query 310, which includes c2Vuc2l0aXZlaW5mbw as a subdomain name of the QNAME. The DNS checker service 308 includes a decoder 303, which decodes various information included within the subdomain names of the original DNS query 310. Note that at this point, the DNS checker service 308 does not know whether any sensitive information within the DNS query 310 is encoded, and also does not know an encoding technique that may have been used to encode the sensitive information. Accordingly, in an example, the decoder 303 implements a plurality of decoding techniques corresponding to a plurality of known encoding techniques.

For example, the decoder 303 decodes the DNS query 310 (i) in accordance with a first decoding technique, to generate a first decoded DNS query 313a, (ii) in accordance with a second decoding technique, to generate a second decoded DNS query 313b, (iii) in accordance with a P^{th} decoding technique, to generate a P^{th} decoded DNS query 313P, and so on, as illustrated in FIG. 3. Merely as an example, a sensitive information 306 within the DNS query 310 may be encoded with any encoding technique, such as using character encoding, base64 encoding, Huffman encoding or lossless compression, run-length encoding (RLE), ASCII encoding, and/or another type of encoding technique. However, as the decoder 303 is unsure about an encoding technique used to encode the sensitive information 306 (or unsure as to whether the any encoded version of any sensitive information is at all included within the DNS query 310), the decoder 303 decodes the DNS query in accordance with a plurality of known decoding techniques, to generate the plurality of decoded DNS queries 313a, 313b, ..., 313P.

A correlation service 315 aims to correlate each of the plurality of decoded DNS queries 313a, 313b, ..., 313P, as well as the original DNS query 310, with the sensitive information 306, 307a, ..., 307N. Upon detecting a positive correlation or match between (i) any of the plurality of decoded DNS queries 313a, 313b, ..., 313P and the original DNS query 310 and (ii) any of the sensitive information 306, 307a, ..., 307N, a match flag 317 is issued. In the example of FIG. 3, a decoded version of the DNS query 310, which is decoded using base64 decoding, matches with the sensitive information 306. For example, the subdomain name c2Vuc2l0aXZlaW5mbw, when decoded using base64 decoding, results in text “sensitiveinfo,” which matches with the text of the sensitive information 310. Accordingly, the DNS query 310 is blocked from being transmitted to its target destination (symbolically illustrated with the box labelled “block 305” in FIG. 3). In an example, the DNS checker service 308 issues a match flag 317 indicating blockage of passage of the DNS query 310 that possibly includes sensitive information.

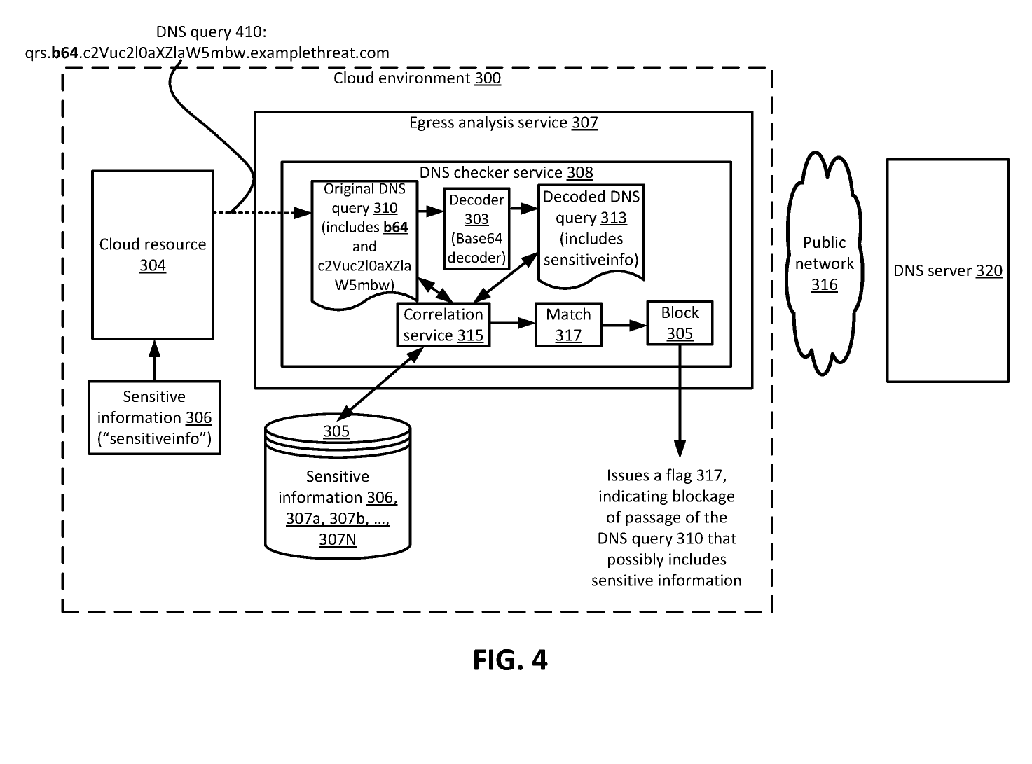

FIG. 4 illustrates a block diagram of a cloud environment 300 that includes (i) a cloud resource 304 transmitting DNS queries to outside the cloud environment 300, where a DNS query 410 includes sensitive information in an encoded form, and an indication of an encoding scheme used for encoding the sensitive information, and (ii) an egress analysis service 307 analyzing the DNS queries for possible anomalous issues, and selectively blocking passage of a DNS query 410 in response to detection of an anomalous issue associated with the DNS query 410.

Similar components in the cloud environment 300 of FIGS. 3 and 4 are labelled using the same labels. In FIG. 3, the DNS query 310 included an encoded version of sensitive text, without any indication about an encoding technique to generate the encoded version of sensitive text. Accordingly, the decoder 303 decodes the DNS query using a plurality of known decoding techniques. In contrast, in FIG. 4, the DNS query 410 itself includes an indication of the encoding scheme used for encoding the sensitive information. The cloud resource 304 may include such information within the DNS query 410, e.g., such that the DNS server 320 (which is supposed to receive the DNS query 410) can select an appropriate type of decoding technique to decode the DNS query 410. For example, the threat actor can configure the cloud resource 304 and the DNS server 320, such that the DNS server 320 can identify the indication of the encoding technique used from within the DNS query 410, and the DNS server 320 can then successfully decode the encoded sensitive information within the DNS query 410.

For example, the DNS query 410 includes the text “c2Vuc2l0aXZlaW5mbw,” which is a base64 encoded version of the text “sensitiveinfo.” Additionally, the DNS query 410 includes the text “b64,” which is an abbreviated label for base64 encoding. Note that instead of b64, the DNS query 410 may also include base64, or 64, or another text including an indication that base64 encoding is used for the DNS query 410.

Once the decoder 303 notices the text “b64” within the DNS query 310, the decoder 303 knows to decode the DNS query 410 using at least base64 encoding. Accordingly, the decoder 303 decodes the text “c2Vuc2l0aXZlaW5mbw” within the DNS query 410 using base64 decoding, to generate the decoded text “sensitiveinfo.” The correlation service 315 matches this with the sensitive information 306. Accordingly, the DNS query 410 is blocked from being transmitted to its target destination (symbolically illustrated with the box labelled “block 305” in FIG. 4). In an example, the DNS checker service 308 issues a match flag 317 indicating blockage of passage of the DNS query 310 that possibly includes sensitive information.

A threat actor aiming to obfuscate the exfiltration attempt or avoid them being observed across the DNS query may use an appropriate type of encoding (such as base64 encoding) of information of the namespace, e.g., as also described above with respect to FIGS. 3-4. As long as the domain name (e.g., examplethreat.com used in FIGS. 3 and 4) is intact and used, the value will be transmitted to the DNS server 320 (such as an authoritative DNS resolver) being used to collect the DNS query for the threat actor. In an example, the threat actor cannot obfuscate (or encode using an encoding technique) the domain name, as the local recursive resolver has to issue a query to the authoritative resolver to send the data back to the server. Thus, for example, examplethreat.com itself may not be obfuscated. Accordingly, the cloud resource 304 may append sensitive information and other search domains aids to the domain name, e.g., as a part of the subdomain name. Thus, some information may be obfuscated by an encoding technique, but the rest of the details (such as domain name) in the FQDN may be present. Note that in an example, when the threat actor adds the encoded (such as base64 encoded) sections, the above-described DNS checker service may detect this (see FIGS. 3-4), where the DNS checker service may be specifically looking for known data encoding methods in DNS queries, which would provide feedback that queries made to that domain examplethreat.com as a whole should be analyzed.

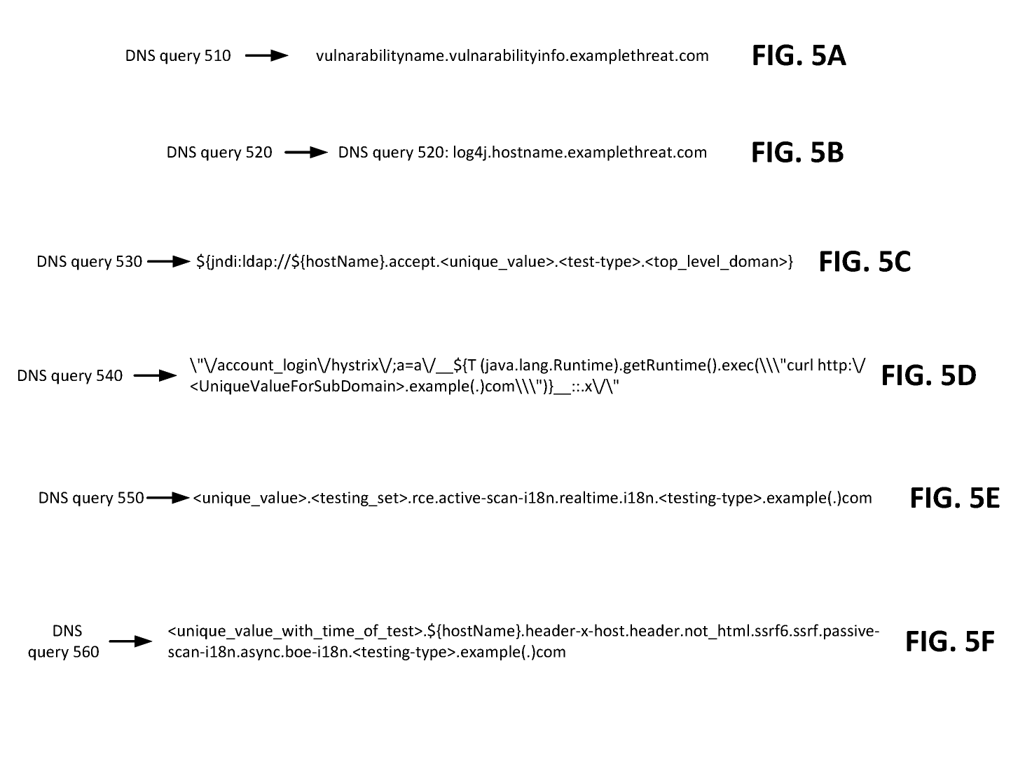

FIG. 5A illustrates an example DNS query 510 that includes an indication of a vulnerability to be exploited, as well as relevant information associated with the vulnerability. The DNS query 520 may be generated by any of the cloud resources 104, 204, or 304 described above. Merely as an example, the DNS query 510amay be of the form vulnarabilityname.vulnarabilityinfo.examplethreat.com. The vulnarabilityname indicates a name or at least an indication of a vulnerability, and the vulnarabilityinfo includes additional information that can be used to exploit the vulnerability. The DNS server 120, 220, or 320 may receive the name or at least an indication of the vulnerability, and the additional information that can be used to exploit the vulnerability. from the cloud resource within the cloud environment, and exploit the vulnerability.

In an example, any of the DNS checker service described above can detect such an attempt to exfiltrate such vulnerability information, e.g., by detecting the vulnarabilityname and/or the vulnarabilityinfo from the DNS query 510.

FIG. 5B illustrates an example DNS query 520 that includes an example of a specific vulnerability and associated information embedded within the DNS query 520. The DNS query 520 may be generated by any of the cloud resources 104, 204, or 304 described above. Merely as an example, the DNS query 520 may be of the form log4j.hostname.examplethreat.com. Here, Log4j is a logging framework that helps developers track and record application activity, and is an open-source Java-based utility. On Dec. 9, 2021, a zero-day vulnerability involving arbitrary code execution in Log4j was published. The DNS query 520 also includes additional information that can be used to exploit the Log4j vulnerability. For example, the DNS query 520 includes a host name of an internal cloud resource within a cloud environment (such as any of the cloud environments 100, 200, or 300). The DNS server 120, 220, or 320 may receive this DNS query 520, and aim to exploit the Log4j vulnerability on the cloud resource identified by the hostname within the DNS query 520.

In an example, any of the DNS checker service described above can detect such an attempt to exfiltrate such vulnerability information, e.g., by detecting the log4j text and/or the hostname from the DNS query 520.

FIG. 5C illustrates another DNS query 530 that includes a name of the host, and one or more attributes usable to exploit the name of the host. For example, the DNS query 530 includes a text “jndi,” which is an abbreviation for Java Naming and Directory Interface (JNDI). JNDI is an API that helps Java applications find and use resources and other program objects. Similarly, for example, the DNS query 530 includes ldap, which is an abbreviation for Lightweight Directory Access Protocol (LDAP). LDAP is a protocol that helps users find and access information about people, organizations, and devices on a network. Thus, the DNS query 530 includes the host name and additional information that the threat actor operating the DNS server 120 (or the DNS server 220 or 320) and the cloud resource 104 (or the cloud resource 204 or 304) can use to exploit any of the cloud environments described above. In an example, any of the DNS checker service described above can detect such an attempt to exfiltrate such vulnerability information, as described above.

FIG. 5D illustrates yet another DNS query 540 that includes a name of the host, and one or more attributes usable to exploit the name of the host. In the DNS query 540, the command injection within the DNS query may be targeting a Java platform. In an example, any of the DNS checker service described above can detect such an attempt to exfiltrate such vulnerability information, as described above.

FIG. 5E illustrates yet another DNS query 550 that includes sensitive information, which can be exploited by a threat actor. For example, the DNS query 550 includes a type of vulnerability to be exploited and associated vulnerability information. The DNS query 550 is an example of remoted code execution tests run as part of an active-scan related to internationalization. The internationalization part is abbreviated or otherwise indicated as “i18n,” where the number 18 stands for the number of letters in “internationalization” between “i” and “n.”

Thus, in the above example, the DNS query 550 may have a pre-agreed abbreviation (e.g., .i18n. for “internationalization”). The DNS server, when it sees .i18n., assumes that this stands for internationalization. In an example, a structure of the domain name (e.g., example.com) and often the structure of the fully qualified domain name (FQDN) are pre-agreed in the sense that control over the authoritative resolution of the domain is required to receive the information. The subdomains as shown like <testing-type>.example(.)com or <testing-type>.<hostname>.example(.)com > may allow the data as received to be processed into streams for action. If the target has a relatively long name, then the DNS query may segment the target name by hostname, then by the vulnerability or test type. The i18n stream may point the attacker to potential means to exploit international character sets or encoding. In an example, any of the DNS checker service described above can detect such an attempt to exfiltrate such vulnerability information, as described above.

FIG. 5F illustrates a further DNS query 560 that sensitive information that can be exploited by a threat actor. In the DNS query 560, additional details are included specifying this domain name was placed in the host header-x field, and not in the HTML, as part of a server-side request forgery test. In an example, any of the DNS checker service described above can detect such an attempt to exfiltrate such vulnerability information, as described above.

In an example, the threat actor may also utilize unofficial and/or typo squatting python packages. Typosquatting is a type of cyber-attack where attackers register domain names that are misspelled versions of legitimate websites. As the python package is installed, it is intended to trigger command injection domain names to resolve relaying information about the population of endpoints using the typo-squatted package to the information collection DNS server. By collecting and processing the resolutions and their hostnames, the DNS checker service can detect such attempts for exfiltration, as also described above in further detail.

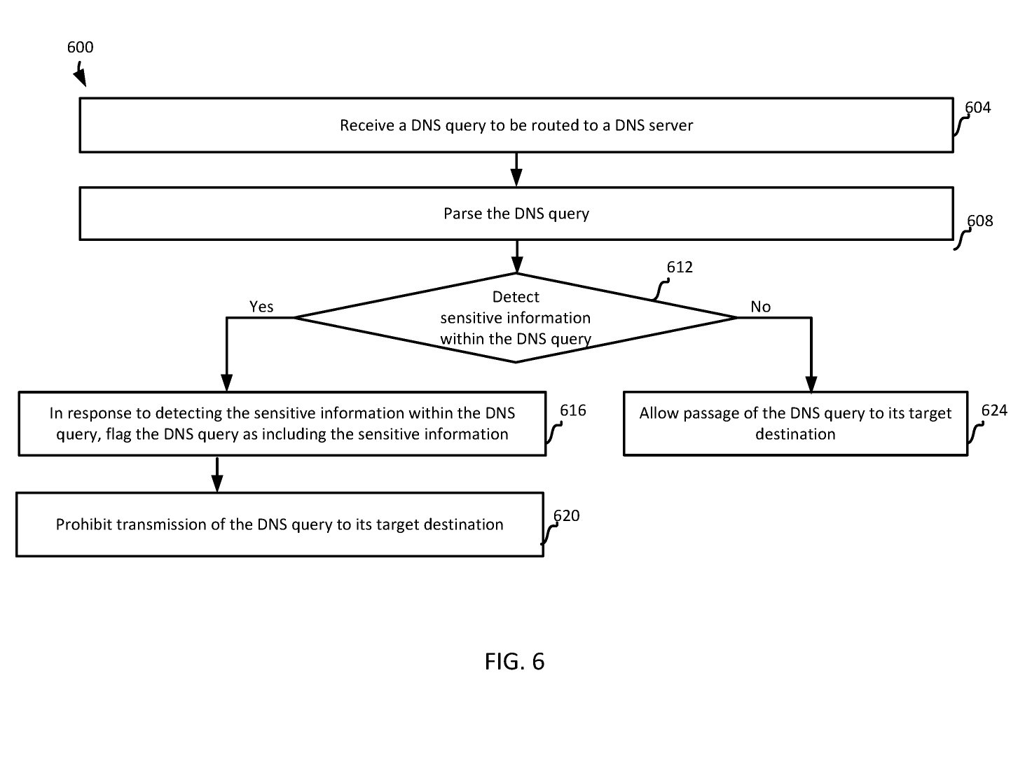

FIG. 6 illustrates a flow chart depicting a method 600 for detection of anomalous DNS queries. At 604, a DNS query to be routed to a DNS server is received, e.g., at a DNS checker service, as described above. At 608, the DNS query is parsed, e.g., by the DNS checker service. In an example, parsing the DNS query involves reading the subdomain names within the QNAME of the DNS query. In an example, parsing the DNS query also involves decoding the subdomain names, e.g., using one or more available decoding techniques.

At 612, a determination is made as to whether sensitive information is detected within the DNS query. For example, an original subdomain name or a decoded subdomain name may correlate with one of a plurality of sensitive information, which results in a detection of sensitive information within the DNS query.

If “Yes” at 612 (e.g., if sensitive information is detected within the DNS query), the method 600 proceeds from 612 to 616. At 616, in response to detecting the sensitive information within the DNS query, the DNS query is flagged as including the sensitive information (e.g., by the DNS checker service). At 620, transmission of the DNS query to its target destination (e.g., to a DNS server) is prohibited or blocked, e.g., by the DNS checker service.

On the other hand, if “No” at 612 (e.g., if sensitive information is not detected within the DNS query), the method 600 proceeds from 612 to 624. At 624, passage of the DNS query to its target destination (e.g., to a DNS server) is allowed, e.g., by the DNS checker service.

### COMPUTER SYSTEM ARCHITECTURE

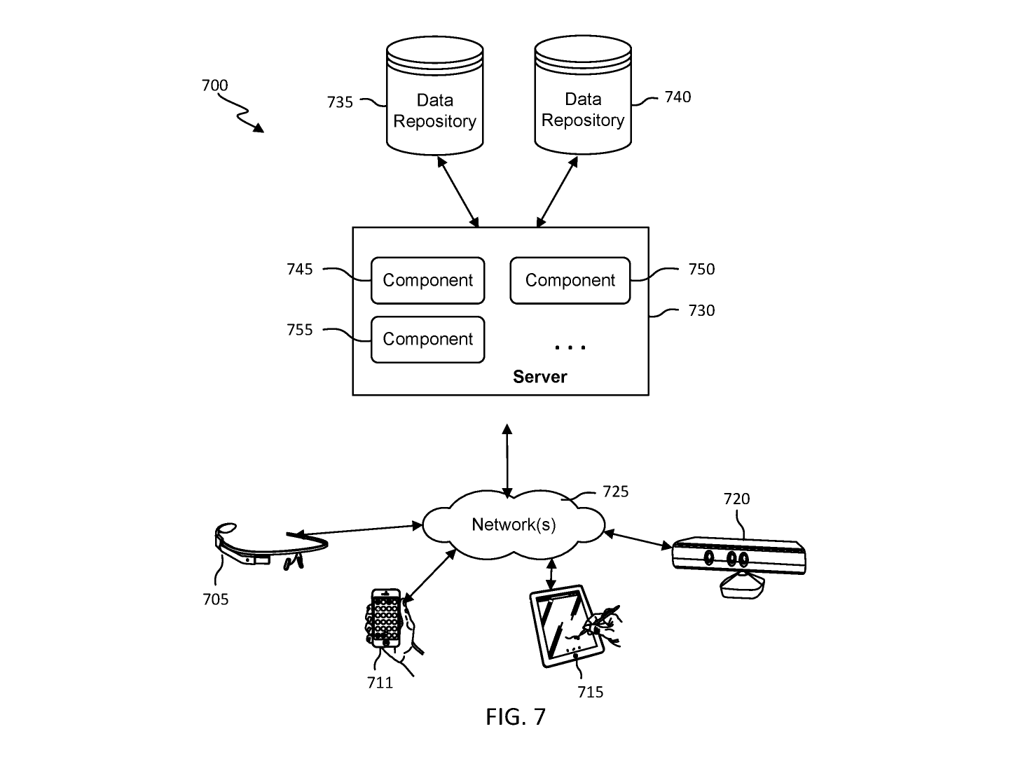

FIG. 7 depicts a simplified diagram of a distributed system 700 for implementing an embodiment. In the illustrated embodiment, distributed system 700 includes one or more client computing devices 702, 704, 706, 708, and/or 710 coupled to a server 714 via one or more communication networks 712. Clients computing devices 702, 704, 706, 708, and/or 710 may be configured to execute one or more applications.

In various aspects, server 714 may be adapted to run one or more services or software applications that enable techniques for detection of anomalous DNS queries.

In certain aspects, server 714 may also provide other services or software applications that can include non-virtual and virtual environments. In some aspects, these services may be offered as web-based or cloud services, such as under a Software as a Service (SaaS) model to the users of client computing devices 702, 704, 706, 708, and/or 710. Users operating client computing devices 702, 704, 706, 708, and/or 710 may in turn utilize one or more client applications to interact with server 714 to utilize the services provided by these components.

In the configuration depicted in FIG. 7, server 714 may include one or more components 720, 722 and 724 that implement the functions performed by server 714. These components may include software components that may be executed by one or more processors, hardware components, or combinations thereof. It should be appreciated that various different system configurations are possible, which may be different from distributed system 700. The embodiment shown in FIG. 7 is thus one example of a distributed system for implementing an embodiment system and is not intended to be limiting.

Users may use client computing devices 702, 704, 706, 708, and/or 710 for techniques for detection of anomalous DNS queries in accordance with the teachings of this disclosure. A client device may provide an interface that enables a user of the client device to interact with the client device. The client device may also output information to the user via this interface. Although FIG. 7 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 712 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 712 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 714 may be composed of one or more general purpose computers, specialized server computers (including, by way of example, PC (personal computer) servers, UNIX® servers, LINUX® servers, mid-range servers, mainframe computers, rack-mounted servers, etc.), server farms, server clusters, a Real Application Cluster (RAC), database servers, or any other appropriate arrangement and/or combination. Server 714 can include one or more virtual machines running virtual operating systems, or other computing architectures involving virtualization such as one or more flexible pools of logical storage devices that can be virtualized to maintain virtual storage devices for the server. In various aspects, server 714 may be adapted to run one or more services or software applications that provide the functionality described in the foregoing disclosure.

The computing systems in server 714 may run one or more operating systems including any of those discussed above, as well as any commercially available server operating system. Server 714 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 714 may include one or more applications to analyze and consolidate data feeds and/or event updates received from users of client computing devices 702, 704, 706, 708, and/or 710. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 714 may also include one or more applications to display the data feeds and/or real-time events via one or more display devices of client computing devices 702, 704, 706, 708, and/or 710.

Distributed system 700 may also include one or more data repositories 716, 718. These data repositories may be used to store data and other information in certain aspects. For example, one or more of the data repositories 716, 718 may be used to store information for techniques for detection of anomalous DNS queries. Data repositories 716, 718 may reside in a variety of locations. For example, a data repository used by server 714 may be local to server 714 or may be remote from server 714 and in communication with server 714 via a network-based or dedicated connection. Data repositories 716, 718 may be of different types. In certain aspects, a data repository used by server 714 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 716, 718 may also be used by applications to store application data. The data repositories used by applications may be of different types such as, for example, a key-value store repository, an object store repository, or a general storage repository supported by a file system.

In one embodiment, server 714 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

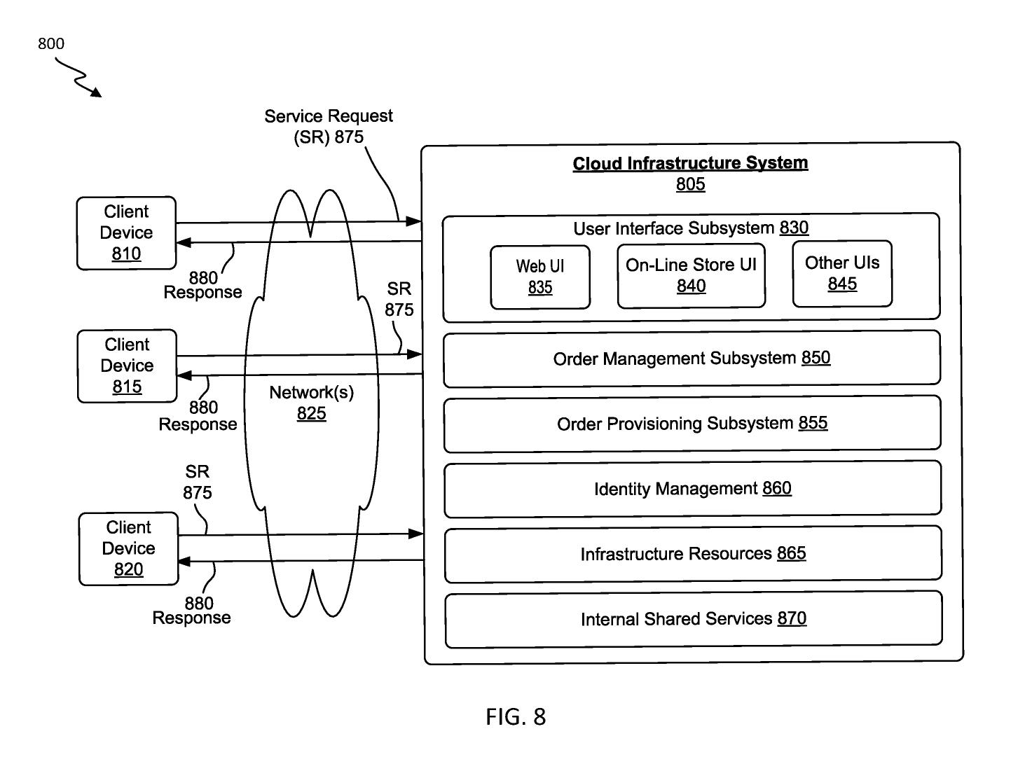

FIG. 8 is a simplified block diagram of a cloud-based system environment in which anomalous DNS queries are detected, in accordance with certain aspects. In the embodiment depicted in FIG. 8, cloud infrastructure system 802 may provide one or more cloud services that may be requested by users using one or more client computing devices 804, 806, and 808. Cloud infrastructure system 802 may comprise one or more computers and/or servers that may include those described above for server 714. The computers in cloud infrastructure system 802 may be organized as general purpose computers, specialized server computers, server farms, server clusters, or any other appropriate arrangement and/or combination.

Network(s) 810 may facilitate communication and exchange of data between clients 804, 806, and 808 and cloud infrastructure system 802. Network(s) 810 may include one or more networks. The networks may be of the same or different types. Network(s) 810 may support one or more communication protocols, including wired and/or wireless protocols, for facilitating the communications.

The embodiment depicted in FIG. 8 is only one example of a cloud infrastructure system and is not intended to be limiting. It should be appreciated that, in some other aspects, cloud infrastructure system 802 may have more or fewer components than those depicted in FIG. 8, may combine two or more components, or may have a different configuration or arrangement of components. For example, although FIG. 8 depicts three client computing devices, any number of client computing devices may be supported in alternative aspects.

The term cloud service is generally used to refer to a service that is made available to users on demand and via a communication network such as the Internet by systems (e.g., cloud infrastructure system 802) of a service provider. Typically, in a public cloud environment, servers and systems that make up the cloud service provider's system are different from the cloud customer’s (“tenant’s”) own on-premise servers and systems. The cloud service provider’s systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 810 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 802 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 802 may include a suite of databases, middleware, applications, and/or other resources that enable provision of the various cloud services.

A SaaS model enables an application or software to be delivered to a tenant’s client device over a communication network like the Internet, as a service, without the tenant having to buy the hardware or software for the underlying application. For example, a SaaS model may be used to provide tenants access to on-demand applications that are hosted by cloud infrastructure system 802. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 802. Cloud infrastructure system 802 then performs processing to provide the services requested in the tenant's subscription order. Cloud infrastructure system 802 may be configured to provide one or even multiple cloud services.

Cloud infrastructure system 802 may provide the cloud services via different deployment models. In a public cloud model, cloud infrastructure system 802 may be owned by a third party cloud services provider and the cloud services are offered to any general public tenant, where the tenant can be an individual or an enterprise. In certain other aspects, under a private cloud model, cloud infrastructure system 802 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 802 and the services provided may be shared by several organizations in a related community. Various other models such as hybrids of the above mentioned models may also be used.

Client computing devices 804, 806, and 808 may be of different types (such as devices 702, 704, 706, and 708 depicted in FIG. 7) and may be capable of operating one or more client applications. A user may use a client device to interact with cloud infrastructure system 802, such as to request a service provided by cloud infrastructure system 802.

In some aspects, the processing performed by cloud infrastructure system 802 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 802 for determining the intent of an utterance. The data used for this analysis may include structured data (e.g., data stored in a database or structured according to a structured model) and/or unstructured data (e.g., data blobs (binary large objects)).

As depicted in the embodiment in FIG. 8, cloud infrastructure system 802 may include infrastructure resources 830 that are utilized for facilitating the provision of various cloud services offered by cloud infrastructure system 802. Infrastructure resources 830 may include, for example, processing resources, storage or memory resources, networking resources, and the like.

In certain aspects, to facilitate efficient provisioning of these resources for supporting the various cloud services provided by cloud infrastructure system 802 for different tenants, the resources may be bundled into sets of resources or resource modules (also referred to as "pods"). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 802 may itself internally use services 832 that are shared by different components of cloud infrastructure system 802 and which facilitate the provisioning of services by cloud infrastructure system 802. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 802 may comprise multiple subsystems. These subsystems may be implemented in software, or hardware, or combinations thereof. As depicted in FIG. 8, the subsystems may include a user interface subsystem 812 that enables users of cloud infrastructure system 802 to interact with cloud infrastructure system 802. User interface subsystem 812 may include various different interfaces such as a web interface 814, an online store interface 816 where cloud services provided by cloud infrastructure system 802 are advertised and are purchasable by a consumer, and other interfaces 818. For example, a tenant may, using a client device, request (service request 834) one or more services provided by cloud infrastructure system 802 using one or more of interfaces 814, 816, and 818. For example, a tenant may access the online store, browse cloud services offered by cloud infrastructure system 802, and place a subscription order for one or more services offered by cloud infrastructure system 802 that the tenant wishes to subscribe to. The service request may include information identifying the tenant and one or more services that the tenant desires to subscribe to. For example, a tenant may place a subscription order for a chatbot related service offered by cloud infrastructure system 802. As part of the order, the client may provide information identifying the input (e.g. utterances).

In certain aspects, such as the embodiment depicted in FIG. 8, cloud infrastructure system 802 may comprise a service management subsystem (OMS) 820 that is configured to process the new order. As part of this processing, OMS 820 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 820 may then invoke the service provisioning subsystem (OPS) 824 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 824 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 802 may send a response or notification 844 to the requesting tenant to indicate when the requested service is now ready for use. In some instances, information (e.g., a link) may be sent to the tenant that enables the tenant to start using and availing the benefits of the requested services.

Cloud infrastructure system 802 may provide services to multiple tenants. For each tenant, cloud infrastructure system 802 is responsible for managing information related to one or more subscription orders received from the tenant, maintaining tenant data related to the orders, and providing the requested services to the tenant or clients of the tenant. Cloud infrastructure system 802 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 802 may provide services to multiple tenants in parallel. Cloud infrastructure system 802 may store information for these tenants, including possibly proprietary information. In certain aspects, cloud infrastructure system 802 comprises an identity management subsystem (IMS) 828 that is configured to manage tenant’s information and provide the separation of the managed information such that information related to one tenant is not accessible by another tenant. IMS 828 may be configured to provide various security-related services such as identity services, such as information access management, authentication and authorization services, services for managing tenant identities and roles and related capabilities, and the like.

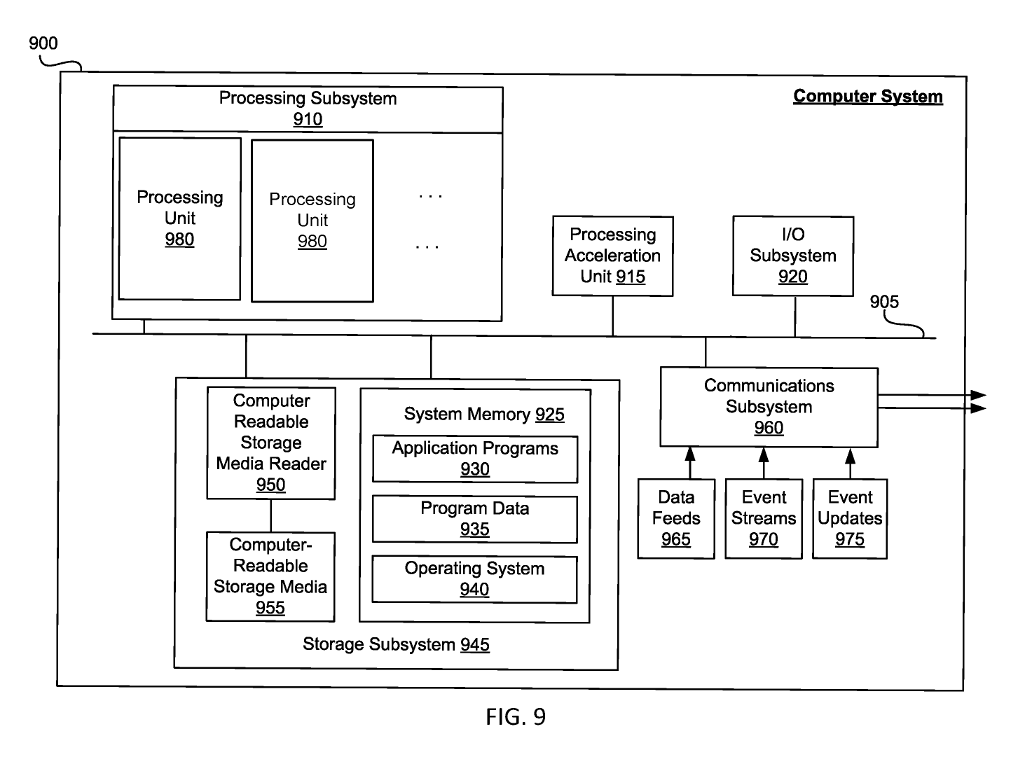

FIG. 9 illustrates an exemplary computer system 900 that may be used to implement certain aspects. As shown in FIG. 9, computer system 900 includes various subsystems including a processing subsystem 904 that communicates with a number of other subsystems via a bus subsystem 902. These other subsystems may include a processing acceleration unit 906, an I/O subsystem 908, a storage subsystem 918, and a communications subsystem 924. Storage subsystem 918 may include non-transitory and/or transitory computer-readable storage media including storage media 922 and a system memory 910.

Bus subsystem 902 provides a mechanism for letting the various components and subsystems of computer system 900 communicate with each other as intended. Although bus subsystem 902 is shown schematically as a single bus, alternative aspects of the bus subsystem may utilize multiple buses. Bus subsystem 902 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 904 controls the operation of computer system 900 and may comprise one or more processors, application specific integrated circuits (ASICs), or field programmable gate arrays (FPGAs). The processors may be single core or multicore processors. The processing resources of computer system 900 can be organized into one or more processing units 932, 934, etc. A processing unit may include one or more processors, one or more cores from the same or different processors, a combination of cores and processors, or other combinations of cores and processors. In some aspects, processing subsystem 904 can include one or more special purpose co-processors such as graphics processors, digital signal processors (DSPs), or the like. In some aspects, some or all of the processing units of processing subsystem 904 can be implemented using customized circuits, such as application specific integrated circuits (ASICs), or field programmable gate arrays (FPGAs).

In some aspects, the processing units in processing subsystem 904 can execute instructions stored in system memory 910 or on computer readable storage media 922. In various aspects, the processing units can execute a variety of programs or code instructions and can maintain multiple concurrently executing programs or processes. At any given time, some or all of the program code to be executed can be resident in system memory 910 and/or on computer-readable storage media 922 including potentially on one or more storage devices. Through suitable programming, processing subsystem 904 can provide various functionalities described above. In instances where computer system 900 is executing one or more virtual machines, one or more processing units may be allocated to each virtual machine.

In certain aspects, a processing acceleration unit 906 may optionally be provided for performing customized processing or for off-loading some of the processing performed by processing subsystem 904 so as to accelerate the overall processing performed by computer system 900.

I/O subsystem 908 may include devices and mechanisms for inputting information to computer system 900 and/or for outputting information from or via computer system 900. In general, use of the term input device is intended to include all possible types of devices and mechanisms for inputting information to computer system 900. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., "blinking" while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 900 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 918 provides a repository or data store for storing information and data that is used by computer system 900. Storage subsystem 918 provides a tangible non-transitory computer-readable storage medium for storing the basic programming and data constructs that provide the functionality of some aspects. Storage subsystem 918 may store software (e.g., programs, code modules, instructions) that when executed by processing subsystem 904 provides the functionality described above. The software may be executed by one or more processing units of processing subsystem 904. Storage subsystem 918 may also provide a repository for storing data used in accordance with the teachings of this disclosure.

Storage subsystem 918 may include one or more non-transitory memory devices, including volatile and non-volatile memory devices. As shown in FIG. 9, storage subsystem 918 includes a system memory 910 and a computer-readable storage media 922. System memory 910 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 900, such as during start-up, may typically be stored in the ROM. The RAM typically contains data and/or program modules that are presently being operated and executed by processing subsystem 904. In some implementations, system memory 910 may include multiple different types of memory, such as static random access memory (SRAM), dynamic random access memory (DRAM), and the like.

By way of example, and not limitation, as depicted in FIG. 9, system memory 910 may load application programs 912 that are being executed, which may include various applications such as Web browsers, mid-tier applications, relational database management systems (RDBMS), etc., program data 914, and an operating system 916. By way of example, operating system 916 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 922 may store programming and data constructs that provide the functionality of some aspects. Computer-readable media 922 may provide storage of computer-readable instructions, data structures, program modules, and other data for computer system 900. Software (programs, code modules, instructions) that, when executed by processing subsystem 904 provides the functionality described above, may be stored in storage subsystem 918. By way of example, computer-readable storage media 922 may include non-volatile memory such as a hard disk drive, a magnetic disk drive, an optical disk drive such as a CD ROM, digital video disc (DVD), a Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 918 may also include a computer-readable storage media reader 920 that can further be connected to computer-readable storage media 922. Reader 920 may receive and be configured to read data from a memory device such as a disk, a flash drive, etc.

In certain aspects, computer system 900 may support virtualization technologies, including but not limited to virtualization of processing and memory resources. For example, computer system 900 may provide support for executing one or more virtual machines. In certain aspects, computer system 900 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 900. Accordingly, multiple operating systems may potentially be run concurrently by computer system 900.

Communications subsystem 924 provides an interface to other computer systems and networks. Communications subsystem 924 serves as an interface for receiving data from and transmitting data to other systems from computer system 900. For example, communications subsystem 924 may enable computer system 900 to establish a communication channel to one or more client devices via the Internet for receiving and sending information from and to the client devices. For example, the communications subsystem may be used to transmit a response to a user regarding the inquiry for a chatbot.

Communications subsystem 924 may support both wired and/or wireless communication protocols. For example, in certain aspects, communications subsystem 924 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 924 can provide wired network connectivity (e.g., Ethernet) in addition to or instead of a wireless interface.

Communications subsystem 924 can receive and transmit data in various forms. For example, in some aspects, in addition to other forms, communications subsystem 924 may receive input communications in the form of structured and/or unstructured data feeds 926, event streams 928, event updates 930, and the like. For example, communications subsystem 924 may be configured to receive (or send) data feeds 926 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 924 may be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 924 may also be configured to communicate data from computer system 900 to other computer systems or networks. The data may be communicated in various different forms such as structured and/or unstructured data feeds 926, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 900 depicted in FIG. 9 is intended only as a specific example. Many other configurations having more or fewer components than the system depicted in FIG. 9 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A non-transitory computer-readable medium including instructions that when executed by one or more processors, cause the one or more processors to perform operations including:
receiving a Domain Name System (DNS) query to be routed to a DNS server;
parsing the DNS query;
detecting sensitive information within the DNS query; and
in response to detecting the sensitive information within the DNS query, flagging the DNS query as including the sensitive information.

2. The non-transitory computer-readable medium of claim 1, wherein the operations include:
in response to flagging the DNS query as including the sensitive information, refraining from transmitting the DNS query to its target destination.

3. The non-transitory computer-readable medium of claim 1, wherein detecting the sensitive information within the DNS query comprises:
detecting the sensitive information within a QNAME (Query Name) portion of the DNS query.

4. The non-transitory computer-readable medium of claim 1, wherein the sensitive information is within a subdomain name of the DNS query.

5. The non-transitory computer-readable medium of claim 1, wherein detecting the sensitive information within the DNS query comprises:
detecting the sensitive information in a cleartext format within the DNS query.

6. The non-transitory computer-readable medium of claim 1, wherein detecting the sensitive information within the DNS query comprises:
parsing the DNS query to identify a text within the DNS query;
decoding the text to generate decoded text; and
identifying the decoded text to include the sensitive information.

7. The non-transitory computer-readable medium of claim 1, wherein detecting the sensitive information within the DNS query comprises:
parsing the DNS query to identify a text within the DNS query;
decoding the text using a plurality of decoding techniques, to respectively generate a plurality of decoded texts; and
parsing the plurality of decoded texts, to identifying the sensitive information within a first decoded text of the plurality of decoded texts.

8. The non-transitory computer-readable medium of claim 1, wherein the sensitive information comprises a name or an identification of a compute resource within a cloud environment.

9. The non-transitory computer-readable medium of claim 1, wherein the operations include:
detecting, within the DNS query, a type of the sensitive information.

10. The non-transitory computer-readable medium of claim 1, wherein the operations include:
detecting, within the DNS query, one of (i) an indication of a type of encoding used to encode the sensitive text within the DNS query, or (ii) an indication of a type of decoding to be used to decode sensitive text within the DNS query.

11. The non-transitory computer-readable medium of claim 1, wherein the operations include:
detecting, within the DNS query, an indication of a type of vulnerability to be exploited using the sensitive information.

12. The non-transitory computer-readable medium of claim 1, wherein:
the DNS query is received from a cloud resource within a client section of a cloud environment; and
the sensitive information is detected within a cloud provider section or an assurance administrator section of the cloud environment.

13. A method comprising:
receiving a Domain Name System (DNS) query to be routed to a DNS server;
parsing the DNS query;
detecting sensitive information within the DNS query; and
in response to detecting the sensitive information within the DNS query, flagging the DNS query as including the sensitive information.

14. The method of claim 13, further comprising:
in response to flagging the DNS query as including the sensitive information, refraining from transmitting the DNS query to its target destination.

15. The method of claim 13, wherein the sensitive information is within a subdomain name of the DNS query.

16. The method of claim 13, wherein detecting the sensitive information within the DNS query comprises:
parsing the DNS query to identify a text within the DNS query;
decoding the text to generate decoded text; and
identifying the decoded text to include the sensitive information.

17. The method of claim 13, wherein detecting the sensitive information within the DNS query comprises:
parsing the DNS query to identify a text within the DNS query;
decoding the text using a plurality of decoding techniques, to respectively generate a plurality of decoded texts; and
parsing the plurality of decoded texts, to identifying the sensitive information within a first decoded text of the plurality of decoded texts.

18. The method of claim 13, wherein the sensitive information comprises a name or an identification of a compute resource within a cloud environment.

19. A system comprising:
one or more processors; and
one or more non-transitory computer-readable media storing instructions, which, when executed by the system, cause the system to perform a set of actions including:
receiving a Domain Name System (DNS) query to be routed to a DNS server;
parsing the DNS query;
detecting sensitive information within the DNS query; and
in response to detecting the sensitive information within the DNS query, flagging the DNS query as including the sensitive information.

20. The system of claim 18, wherein the sensitive information comprises a name or an identification of a compute resource within a cloud environment.
